(19) United States
(12) Patent Application Publication
(10) Pub. No.: US 2014/0186742 A1
(43) Pub. Date: Jul. 3, 2014

(54) CATALYST FOR FUEL CELL, AND ELECTRODE FOR FUEL CELL, MEMBRANE-ELECTRODE ASSEMBLY FOR FUEL CELL, AND FUEL CELL SYSTEM INCLUDING SAME

(71) Applicant: Hyundai Motor Company, Seoul (KR)

(72) Inventor: Mi Hye Yi, Yongin (KR)

(73) Assignee: Hyundai Motor Company, Seoul (KR)

(21) Appl. No.: 13/902,014

(22) Filed: May 24, 2013

(30) Foreign Application Priority Data
Dec. 27, 2012 (KR) 10-2012-0155390

(51) Int. Cl. H01M 4/86

(52) U.S. Cl. CPC H01M 4/8657
USPC 429/482; 429/524

(57) ABSTRACT

A catalyst for an electrode of a membrane-electrode assembly of a fuel cell system is provided herein. More specifically, the catalyst includes a first catalyst including platinum supported on carbon, and a second catalyst including an Ir—Ru alloy.

### CROSS-REFERENCE TO RELATED APPLICATION

This application claims priority to and the benefit of Korean Patent Application No. 10-2012-0155390 filed in the Korean Intellectual Property Office on Dec. 27, 2012, the entire contents of which are incorporated herein by reference.

### BACKGROUND

(a) Field of the Invention

The present disclosure relates to a catalyst for a fuel cell, and an electrode for a fuel cell, a membrane-electrode assembly for a fuel cell, and a fuel cell system including the same.

(b) Description of the Related Art

A fuel cell is a device that converts chemical energy from a fuel (such as hydrogen) into electricity via a chemical reaction with oxygen or another oxidizing agent. Hydrogen is the most common fuel, but hydrocarbons such as natural gas and alcohols like methanol and ethanol are sometimes used as well. Fuel cells are different from batteries in that they require a constant source of fuel and oxygen to run, but they can produce electricity continually for as long as these inputs are supplied. Fuel cells come in many different designs, however, two of the more well-known designs are a polymer electrolyte membrane fuel cell (PEMFC) and a direct methanol fuel cell (DMFC) which uses methanol as a fuel.

Fuel cell systems include a stack having a structure where several to several tens of unit cells formed of a membrane-electrode assembly (MEA) and a separator (bipolar plate) are laminated together. The membrane-electrode assembly includes an anode (“fuel electrode” or “oxidation electrode”) and a cathode (“air electrode” or “reduction electrode”) which are positioned with a polymer electrolyte membrane which has a hydrogen ion conductive polymer interposed therebetween.

During electrical generation within the fuel cell, fuel is supplied to the anode (i.e., the fuel electrode) to be adsorbed on a catalyst of the anode, and oxidized to generate hydrogen ions and electrons, the electrons generated travel toward the cathode (i.e., the oxidation electrode) along an external circuit, and the hydrogen ions are transported through the polymer electrolyte membrane to the cathode. An oxidant is supplied to the cathode, and the oxidant, the hydrogen ions, and the electrons are reacted on the catalyst of the cathode to generate electricity while producing water as a by-product.

These catalyst's, however, tend to become corroded over time and thus are not as durable as most in the industry would like them to be in order for fuel cell systems to applicable to industrial standards, such as vehicle manufacturing. Thus, there is a need for a catalyst that is more durable than those currently produced on the market today.

The above information disclosed in this Background section is only for enhancement of understanding of the background of the invention and therefore it may contain information that does not form the prior art that is already known in this country to a person of ordinary skill in the art.

### SUMMARY

An exemplary embodiment of the present invention provides a catalyst to be applied to an electrode in a membrane electrode assembly within a fuel cell system within for example a vehicle, having excellent durability.

More specifically, an exemplary embodiment of the present invention provides a catalyst for a fuel cell including: a first catalyst (Pt/C) including platinum supported on carbon; and a second catalyst including an iridium-ruthenium (Ir—Ru) alloy. In particular, in some exemplary embodiments of the present invention, the content of the second catalyst may be 1 wt % to 30 wt % based on 100 wt % of the first catalyst. Additionally, the Ir—Ru alloy may be represented by IrₓRu₂₋ₓ (x is 0.9 to 1.1).

In another exemplary embodiment of the present invention provides a cathode for a fuel cell, including: an electrode substrate, and a catalyst layer formed on the electrode substrate and including the catalyst described above.

Furthermore, in yet another exemplary embodiment of the present invention, a membrane-electrode assembly for a fuel cell may include a cathode, an anode, and a polymer electrolyte membrane positioned between the cathode and the anode.

The electrode and the membrane-electrode assembly may be applied to a system in still another exemplary embodiment of the present invention which provides a fuel cell system which includes at least one electrical energy generator including the membrane-electrode assembly and separators positioned on both surfaces of the membrane-electrode assembly; a fuel supplier; and an oxidant supplier. The electrical energy generator may serve to generate electricity through an oxidation reaction of fuel and a reduction reaction of an oxidant. The fuel supplier may serve to supply the fuel to the electrical energy generator, and the oxidant supplier serves to supply the oxidant to the electrical energy generator.

According to the exemplary embodiments of the present invention, since a catalyst for a fuel cell has excellent durability, it is possible to improve power and cycle-life characteristics of the fuel cell as well as improve the industrial applicability of the overall system.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a view schematically illustrating a structure of a fuel cell system according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

According to an exemplary embodiment of the present invention, there is provided a catalyst for a fuel cell including a first catalyst (Pt/C) including platinum supported on a carbon structure, and a second catalyst including an Ir—Ru alloy. The carbon may be embodied as a carrier, and may be for example a crystalline carbon or amorphous carbon. The loading amount of platinum may be implemented in the amount of about 30 wt % to 65 wt % based on 100 wt % of carbon.

The Ir—Ru alloy in the exemplary embodiment of the present invention may be represented by IrₓRu₂₋ₓ (x is about 0.9 to 1.1). Advantageously, when above catalyst composition provides an excellent water decomposition ability (O₂ generating ability, OER (oxygen evolution reaction, a reaction decomposing water to generate oxygen)). In particular, the OER reactivity may be improved in comparison to an Ir—Ru alloy having the composition deviating from the above range, such as for example Ir₂Ru or IrRu₂.

Iridium (Ir) and ruthenium (Ru) are noble metals which are very stable and have exceedingly high water decomposition ability in comparison to Pt at the same voltage (1.6 V). The second catalyst, as noted above, includes an Ir—Ru alloy that is made up of a combination of iridium and ruthenium. The above described Ir—Ru alloy has exceedingly high water decomposition abilities (e.g., O₂ generating ability, OER (oxygen evolution reaction, a reaction decomposing water to generate oxygen)) as compared to Pt, and thus efficiently decomposes water. Accordingly, when the second catalyst is used in the cathode of the fuel cell, when overpotential occurs due to a lack of fuel (e.g. SU/SD (start up/shut down)), corrosion of a carbon carrier of the cathode may be prevented. The principle as to why corrosion of the carbon carrier of the cathode is prevented is as follows.

Generally, when the overpotential occurs (e.g. at the time of SU/SD), a lack of fuel occurs due to air permeating the anode, a lack of hydrogen ions (H⁺) is effectuated by the lack of fuel, and a lack of the hydrogen ions is supplemented through corrosion of the carbon carrier of the cathode, not the anode to perform operation [Reaction Equation: C+2H₂O→CO₂+4H⁺+4e⁻].

In the exemplary embodiment of the present invention, the second catalyst having excellent OER reactivity may be used as the catalyst layer to decompose water existing in the catalyst layer instead of the carbon carrier of the cathode [Reaction Equation: 2H₂O→O₂+4H⁺+4e⁻], thus generating the hydrogen ions to prevent corrosion of the carbon carrier.

A mixing ratio of the first catalyst and the second catalyst may be adjusted so that the content of the second catalyst is about 1 wt % to 30 wt % based on 100 wt % of the first catalyst. When the mixing ratio of the first catalyst and the second catalyst is in the aforementioned range, it is desirable that optimum oxidization resistance of carbon may be obtained.

Another exemplary embodiment of the present invention provides a cathode for a fuel cell, including a catalyst layer including the catalyst and an electrode substrate. The catalyst layer may further include a binder resin in order to improve adhesion of the catalyst layer and transfer protons.

The binder resin may be a polymer resin having proton conductivity. Examples of the binder resin may include a polymer resin having a cation exchange group selected from a sulfonic acid group, a carboxylic acid group, a phosphoric acid group, a phosphonic acid group, and derivatives thereof at a side chain thereof. Further, specific examples of the polymer resin may include at least one proton conductive polymers selected from a group consisting of a fluoro-based polymer, a benzimidazole-based polymer, a polyimide-based polymer, a polyetherimide-based polymer, a polyphenylene sulfide-based polymer, a polysulfone-based polymer, a polyethersulfone-based polymer, a polyetherketone-based polymer, a polyether-etherketone-based polymer, or a polyphenylquinoxaline-based polymer. More specific examples of the polymer resin may include poly(perfluorosulfonic acid), poly(perfluorocarboxylic acid), and a copolymer of tetrafluoroethylene and fluorovinyl ether including a sulfonic acid group. Alternatively, the examples thereof may include a proton conductive polymer where a cation exchange group selected from a group consisting a sulfonic acid group, a carboxylic acid group, a phosphoric acid group, a phosphonic acid group, and a derivative thereof is bonded to one polymer of aryl ketone, poly(2,2′-m-phenylene)-5,5′-bibenzimidazole [poly(2,2′-m-phenylene)-5,5′-bibenzimidazole] or poly(2,5-benzimidazole) at a side chain thereof.

The binder resin may be used singularly or in combination. In particular, the binder resin may be used along with non-conductive polymers to improve adherence with a polymer electrolyte membrane. The binder resin may be used in a controlled amount to adapt to their purposes.

Examples of the non-conductive compound may include at least one selected from polytetrafluoroethylene (PTFE), a tetrafluoroethylene-hexafluorpropylene copolymer (FEP), a tetrafluoroethylene-perfluoroalkylvinylether copolymer (PFA), ethylene/tetrafluoroethylene (ETFE), an ethylenechlorotrifluoro-ethylene copolymer (ECTFE), polyvinylidene fluoride, a polyvinylidene fluoride-hexafluoropropylene copolymer (PVdF-HFP), dodecylbenzene sulfonic acid, or sorbitol.

The electrode substrate serves to diffuse fuel and the oxidant into the catalyst layer while supporting the electrode, thus allowing the fuel and the oxidant to easily approach the catalyst layer. As the electrode substrate, a conductive substrate may be used, and a representative example thereof includes carbon paper, carbon cloth, or carbon felt, but is not limited thereto.

The electrode substrates may be treated with a fluorine-based resin to be water-repellent to prevent deterioration of diffusion efficiency due to water generated during operation of a fuel cell. Examples of the fluorine-based resin may include polytetrafluoroethylene, polyvinylidene fluoride, polyhexafluoropropylene, polyperfluoroalkylvinylether, polyperfluorosulfonyl fluoride alkoxyvinyl ether, fluorinated ethylene propylene, polychlorotrifluoroethylene, or a copolymer thereof.

Further, a microporous layer for improving reactant diffusion efficiency in the electrode substrate may be further included. The microporous layer may generally include conductive powder having a small particle diameter, for example, carbon powder, carbon black, acetylene black, active carbon, carbon fibers, fullerene, carbon nanotubes, carbon nano-wires, carbon nano-horns, or carbon nano-rings.

The microporous layer is formed by applying a composition including conductive powder, a binder resin, and a solvent on the conductive substrate. The binder resin preferably may include polytetrafluoroethylene, polyvinylidene fluoride, polyhexafluoropropylene, polyperfluoroalkylvinylether, polyperfluorosulfonyl fluoride, alkoxyvinyl ether, polyvinyl alcohol, cellulose acetate, a copolymer thereof, or the like. The solvent preferably may include alcohols such as ethanol, isopropyl alcohol, n-propyl alcohol, or butyl alcohol, water, dimethyl acetamide, dimethyl sulfoxide, N-methylpyrrolidone, tetrahydrofuran, or the like. Examples of a coating process may include a screen printing method, a spray coating method, a coating method using a blade (e.g., a doctor blade), or the like according to viscosity of the composition, but are not limited thereto.

Another exemplary embodiment of the present invention provides a membrane-electrode assembly for a fuel cell, including: a cathode; an anode; and a polymer electrolyte membrane positioned between the cathode and the anode.

The anode may include a catalyst layer having a catalyst and an electrode substrate. In this case, the electrode substrate may be any one used on the cathode.

Examples of the catalyst may include platinum, ruthenium, osmium, a platinum-ruthenium alloy, a platinum-osmium alloy, a platinum-palladium alloy, a platinum-M alloy (M is at least one transition metals selected from Ga, Ti, V, Cr, Mn, Fe, Co, Ni, Cu, Zn, Sn, Mo, W, Rh, or Ru), or a combination thereof. Specific examples of the catalyst may include at least one metals selected from Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, or Pt/Ru/Sn/W.

Such a catalyst may be a metal itself (black type) or supported on a carbon carrier. Since a process of supporting the metal on the carrier is widely known in the art, the process may be easily understood by the person with ordinary skill in the art even though a detailed description thereof is omitted in the present specification.

The polymer electrolyte membrane may be any polymer electrolyte membrane made of a polymer resin having proton conductivity that is used for a polymer electrolyte membrane of a fuel cell. Representative examples thereof may include a polymer resin having a cation exchange group selected from the group consisting of a sulfonic acid group, a carboxylic acid group, a phosphoric acid group, a phosphonic acid group, and a derivative thereof at a side chain.

Representative examples of the polymer resin may include at least one selected from a fluoro-based polymer, a benzimidazole-based polymer, a polyimide-based polymer, a polyetherimide-based polymer, a polyphenylene sulfide-based polymer, a polysulfone-based polymer, a polyethersulfone-based polymer, a polyetherketone-based polymer, a polyether-etherketone-based polymer, or a polyphenylquinoxaline-based polymer. Representative examples of the polymer resin may include a poly(perfluorosulfonic acid) (e.g., generally, commercially available as Nafion), a poly(perfluorocarboxylic acid), and a copolymer of tetrafluoroethylene and fluorovinyl ether including a sulfonic acid group. Further, the examples thereof may include a matter where a cation exchange group selected from a sulfonic acid group, a carboxylic acid group, a phosphoric acid group, a phosphonic acid group, and derivatives is bonded to at least one polymers selected from aryl ketone, poly(2,2′-m-phenylene)-5,5′-bibenzimidazole [poly(2,2′-m-phenylene)-5,5′-bibenzimidazole] or poly(2,5-benzimidazole) at a side chain thereof.

Another exemplary embodiment of the present invention provides a fuel cell system including at least one electrical energy generator, a fuel supplier, and an oxidant supplier.

The electrical energy generator includes a membrane-electrode assembly and a separator (referred to a bipolar plate) according to the exemplary embodiment of the present invention. The electrical energy generator serves to generate electricity through an oxidation reaction of fuel and a reduction reaction of an oxidant. The fuel supplier serves to supply the fuel to the electrical generator, and the oxidant supplier serves to supply the oxidant such as oxygen or air to the electrical energy generator.

In the exemplary embodiment of the present invention, hydrogen or hydrocarbon fuel in a gas or liquid state may be included as the fuel. Representative examples of the hydrocarbon fuel may include methanol, ethanol, propanol, butanol, or natural gas.

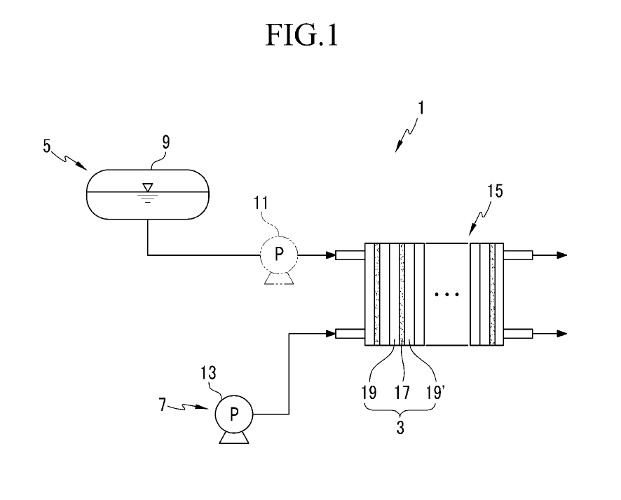

A schematic structure of the fuel cell system according to the exemplary embodiment of the present invention is illustrated in FIG. 1, and will be described in details with the reference to FIG. 1 as follows. The structure illustrated in FIG. 1 represents a system supplying fuel and an oxidant to the electrical energy generator via a pump, but the fuel cell system of the present invention is not limited to this structure, and of course, a fuel cell system structure using a diffusion manner without a pump may be used.

A fuel cell system 1 according to the exemplary embodiment of the present invention is constituted to include at least one electrical energy generator 3 generating electrical energy through the oxidation reaction of fuel and the reduction reaction of the oxidant, a fuel supplier 5 supplying the fuel, and an oxidant supplier 7 supplying the oxidant to the electrical energy generator 3.

Further, the fuel supplier 5 may include a fuel tank 9 that stores fuel, and a fuel pump 11 connected to the fuel tank 9. The fuel pump 11 serves to exhaust the fuel stored in the fuel tank 9 by utilizing predetermined pumping force to remove the fuel from the fuel tank 9. Likewise, the oxidant supplier 7 supplying the oxidant to the electrical energy generator 3 may include at least one oxidant pump 13 absorbing the oxidant by the predetermined pumping force.

The electrical energy generator 3 includes a membrane-electrode assembly 17 performing oxidation and reduction reactions of fuel and the oxidant, and separators 19 and 19′ for supplying fuel and the oxidant to both sides of the membrane-electrode assembly. As such, least one electrical energy generator 3 is assembled to constitute a stack 15, although more commonly a plurality of electrical energy generators 3 are stacked consecutively to form the stack 15.

Hereinafter, a preferred Example of the present invention will be described. However, the following Example is only the preferred Example of the present invention, but the present invention is not limited to the following Example.

### EXAMPLE 1

2.0 g of the Pt/C first catalyst (loading amount of Pt: 60 wt %) and 0.04 g of the IrₓRu₂₋ₓ (x is 1) second catalyst that is the Ir—Ru alloy were added to 2.5 ml of distilled water to prepare the catalyst liquid.

After 3.7 g of ionomer (Hyflon) (aqueous solution obtained by adding 24.5 wt % of the Hyflon polymer to 100 wt % of water) was added as the binder to the catalyst solution and agitated, ultrasonic wave mixing was then performed for 30 min 9.0 g of butanol and 6.1 g of isopropyl alcohol were then added to the obtained mixture and agitated, ultrasonic wave mixing was performed for every 30 minutes for five iterations to prepare the catalyst composition. The catalyst composition was then coated on a carbon paper substrate and dried to prepare an cathode. Subsequently, after Pt/C was added to a Nafion solution to prepare a composition for an anode, the composition was coated and dried to prepare an anode.

The membrane-electrode assembly was manufactured by using the cathode, the anode, and the commercial Nafion (perfluorosulfonic acid) polymer electrolyte membrane, and used as a unit battery.

It was confirmed that the unit battery using the above composition had excellent durability, increased operation efficiency, and excellent battery performance as a result.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A catalyst for a cathode of a fuel cell comprising:
a first catalyst including platinum supported on carbon; and
a second catalyst including an iridium-ruthenium (Ir—Ru) alloy.

2. The catalyst for a cathode of a fuel cell of claim 1, wherein:
a content of the second catalyst is about 1 wt % to 30 wt % based on 100 wt % of the first catalyst.

3. The catalyst for a cathode of a fuel cell of claim 1, wherein the Ir—Ru alloy is IrₓRu_{2-x —}wherein x is about 0.9 to 1.1.

4. A cathode for a fuel cell comprising:
an electrode substrate; and
a cathode catalyst formed on the electrode substrate,
wherein the cathode catalyst is the catalyst of claim 1.

5. A membrane-electrode assembly for a fuel cell comprising:
a cathode including an electrode substrate and a catalyst layer formed on the electrode substrate, wherein the catalyst layer on the cathode is comprises the catalyst of claim 1;
an anode; and
a polymer electrolyte membrane positioned between the cathode and the anode.

6. A fuel cell system comprising:
at least one electrical energy generator including the membrane-electrode assembly of claim 5 and separators positioned on both surfaces of the membrane-electrode assembly and generating electrical energy through an oxidation reaction of fuel and a reduction reaction of an oxidant;
a fuel supplier supplying the fuel to the electrical energy generator; and
an oxidant supplier supplying the oxidant to the electrical energy generator.
